(19) United States
(12) Patent Application Publication
(10) Pub. No.: US 2015/0115856 A1
(43) Pub. Date: Apr. 30, 2015

(54) MOTOR DRIVE CONTROLLER AND MOTOR DRIVE CONTROL METHOD

(71) Applicant: SAMSUNG ELECTRO-MECHANICS CO., LTD., Suwon-Si (KR)

(72) Inventor: Tae Ho LIM, Suwon-Si (KR)

(73) Assignee: SAMSUNG ELECTRO-MECHANICS CO., LTD., Suwon-Si (KR)

(21) Appl. No.: 14/253,523

(22) Filed: Apr. 15, 2014

(30) Foreign Application Priority Data
Oct. 30, 2013 (KR) 10-2013-0129993

(51) Int. Cl. H02P 1/02

(52) U.S. Cl. CPC H02P 1/02
USPC 318/476; 318/474

(57) ABSTRACT

An motor drive controller may include: A mode control unit calculating a pulse frequency of a pulse width modulation (PWM) signal provided from an outside and generating an operating signal according to the calculated pulse frequency of the PWM signal, a regulator receiving the operating signal, transitioning to an enable state based on the operating signal, and generating a driving voltage and a motor control module receiving the driving voltage from the regulator and controlling an operation of a motor. The mode control unit is configured to set up a sleep mask time using a clock signal provided from the outside and control the regulator to maintain the enable state during the sleep mask time.

### CROSS-REFERENCE TO RELATED APPLICATION

This application claims the benefit of Korean Patent Application No. 10-2013-0129993 filed on Oct. 30, 2013, with the Korean Intellectual Property Office, the disclosure of which is incorporated herein by reference.

### BACKGROUND

The present disclosure relates to a motor drive controller and a motor drive control method.

A motor control module may not operate a motor continuously, and may be in a stopped state while not operating the motor through instructions from an external master unit. The stopped state of the motor control module is referred to as a sleep mode and a transition from the sleep mode to an operating mode is referred to as a wake-up operation.

In order to make a transition of the motor control module to a sleep mode, it is necessary to receive a sleep signal from the external master unit. Similarly, in order to wake the motor control module up, it is necessary to receive a wake-up signal from the external master unit.

As such, while the motor control module enters the sleep mode and is woken-up to be operated through the instructions of the external master unit, a time during which the motor is not operated may be present. That is, although the motor control module is operated in a non-sleep mode, a time during which the motor is not operated may be present. Therefore, since the motor control module is continuously operated during the time during which the motor is not operated, internal power may be consumed.

### SUMMARY

An aspect of the present disclosure may provide a motor drive controller and a motor drive control method for preventing a motor control module from being re-transitioned to a sleep mode by a sleep signal provided from the outside during a process (a sleep mask time) in which the motor control module is woken up, in order to control the sleep mode and a wake-up operation for low power management of the motor control module. According to an aspect of the present disclosure, a motor drive controller may include: A motor drive controller, comprising: a mode control unit calculating a pulse frequency of a pulse width modulation (PWM) signal provided from an outside and generating an operating signal according to the calculated pulse frequency of the PWM signal; a regulator receiving the operating signal, transitioning to an enable state based on the operating signal, and generating a driving voltage; and a motor control module receiving the driving voltage from the regulator and controlling an operation of a motor, wherein the mode control unit is configured to set up a sleep mask time using a clock signal provided from the outside and control the regulator to maintain the enable state during the sleep mask time.

The mode control unit may generate the operating signal when the pulse frequency of the PWM signal exceeds a preset frequency.

The mode control unit may generate the operating signal when the PWM signal is a high-level signal.

The mode control unit may block a sleep signal provided from the outside during the sleep mask time and control the regulator to maintain the enable state.

The mode control unit may include: a glitch remover removing glitches from the PWM signal; a counter counting the pulse frequency of the PWM signal; a sleep mask unit receiving a sleep signal from the outside; and a latch circuit unit receiving the PWM signal from the glitch remover and a signal output from the sleep mask unit and generating the operating signal.

The counter may set the sleep mask time using the clock signal.

The sleep mask unit may provide a high output signal to the latch circuit unit during the sleep mask time so that the regulator is maintained in the enable state.

According to another aspect of the present disclosure, a motor drive controller may include: a mode control unit generating an operating signal when a duty of a PWM signal provided from the outside satisfies a preset condition by monitoring the duty of the PWM signal or when a wake-up signal is received from the outside; a regulator receiving the operating signal, transitioning to an enable state based on the operating signal, and generating a driving voltage; and a motor control module receiving the driving voltage from the regulator to be transitioned to a normal mode, wherein the mode control unit may include a sleep mask unit controlling the motor control module to maintain the normal mode for a preset time after the mode control unit generates the operating signal and provides the generated operating signal to the regulator.

The mode control unit may include: a glitch remover removing glitches from the PWM signal; a counter receiving a clock signal provided from the outside and counting a sleep mask time; and a latch circuit unit receiving the PWM signal from the glitch remover and a signal output from the sleep mask unit and generating the operating signal, wherein the signal output from the sleep mask unit may have a high level during the preset time.

The mode control unit may count a case in which a duty ratio of the PWM signal exceeds 0% and generate the operating signal when the counted case exceeds a preset value.

The mode control unit may generate a signal transitioning the regulator to an enable state upon receiving asleep signal when the motor control module is in a normal mode and provide the generated signal to the regulator.

According to another aspect of the present disclosure, a motor drive control method may include: receiving, in a mode control unit, a PWM signal from the outside; monitoring the PWM signal and determining whether the PWM signal satisfies a preset condition; generating, by the mode control unit, an operating signal when the PWM signal satisfies the preset condition and providing the operating signal to a regulator; transitioning the regulator to an enable state by receiving the operating signal and generating a driving voltage; controlling, by the mode control unit, the regulator to maintain the enable state during a sleep mask time which is set using a clock signal provided from the outside; and receiving, in the motor control module, the driving voltage from the regulator and transitioning the motor control module to a normal mode.

The determining whether the PWM signal satisfies the preset condition may include: removing, by a glitch remover, glitches from the PWM signal provided from the outside; counting a pulse frequency of the PWM signal provided from the outside; and comparing the counted pulse frequency of the PWM signal with a preset frequency to determine whether the counted pulse frequency of the PWM signal exceeds the preset frequency.

The determining whether the PWM signal satisfies the preset condition may include determining whether the PWM signal is a high-level signal.

The controlling of the regulator to maintain the enable state may include: setting the sleep mask time using the clock signal from the outside, and controlling the regulator to maintain the enable state during the set sleep mask time.

The method may further include: generating, by the mode control unit, a stop signal upon receiving a sleep signal when the motor control module is in a normal mode, providing, by the mode control unit, the stop signal to the regulator, and receiving, in the regulator, the stop signal and transitioning the regulator to a disabled state.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram illustrating a motor drive controller according to an exemplary embodiment of the present disclosure;

FIG. 2 is a block diagram illustrating details of a mode control unit in the motor drive controller of FIG. 1;

FIG. 3 is a diagram illustrating characteristics of signals associated with the motor drive controller of FIG. 1;

FIG. 4 is a diagram illustrating simulation results of the signals of FIG. 3;

FIG. 5 is a flowchart illustrating a motor drive control method according to another exemplary embodiment of the present disclosure;

FIG. 6 is a flowchart showing a method of determining whether a pulse width modulation (PWM) signal satisfies a preset condition in the motor drive control method illustrated in the flowchart of FIG. 5;

FIG. 7 is a flowchart illustrating a method of controlling a regulator to maintain an enable state during a sleep mask time in the motor drive control method illustrated in the flowchart of FIG. 5; and

FIG. 8 is a flowchart illustrating details of the motor drive control method illustrated in the flowchart of FIG. 5.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

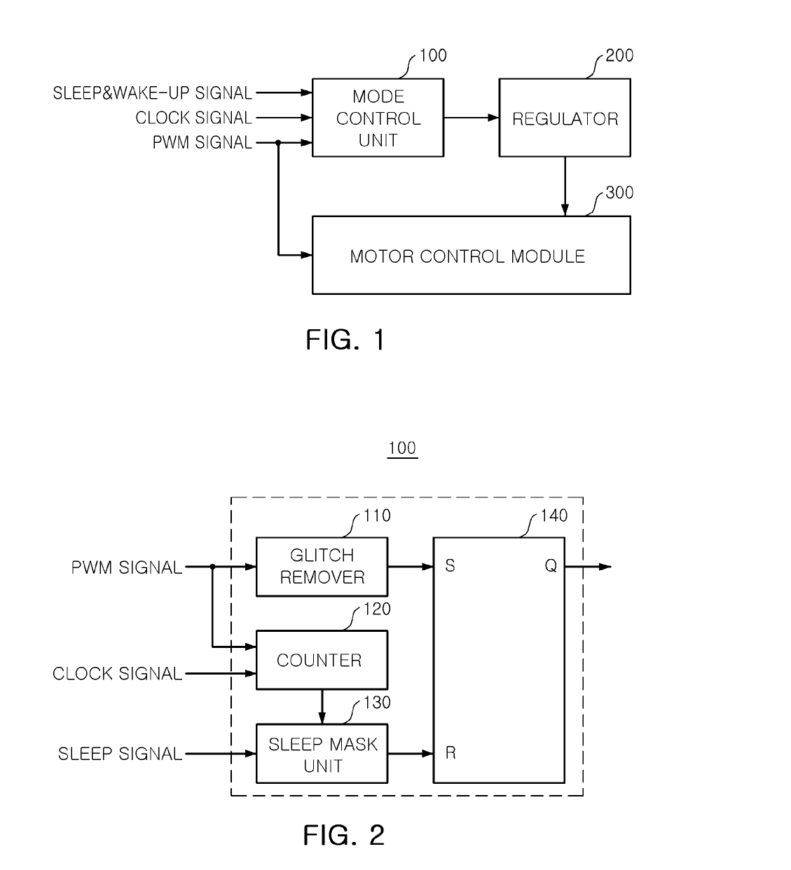

FIG. 1 is a block diagram illustrating a motor drive controller according to an exemplary embodiment of the present disclosure.

Referring to FIG. 1, a motor drive controller according to an exemplary embodiment of the present disclosure may include a mode control unit 100, a regulator 200, and a motor control module 300.

The mode control unit 100 may receive a pulse width modulation (PWM) signal, a clock signal, and a sleep/wake-up signal from the outside. In this case, the mode control unit 100 may receive the PWM signal from the outside and calculate a pulse frequency of the PWM signal. The mode control unit 100 may generate an operating signal using the calculated pulse frequency of the PWM signal and provide the operating signal to the regulator 200.

More specifically, the mode control unit 100 may calculate the pulse frequency of the PWM signal and generate the operating signal when the pulse frequency exceeds a preset frequency. The mode control unit 100 may continuously monitor the PWM signal when the motor control module 300 is in a sleep mode. As a result of monitoring, when the pulse of the PWM signal is received, the motor control module 300 may be woken-up. In this case, since the PWM signal is provided from the outside of the motor drive controller, it may have a plurality of noise components. Therefore, when the motor control module 300 is woken-up because one PWM signal pulse is input, the motor may malfunction due to the noise components, such as glitches.

In order to prevent the malfunctioning of the motor as described above, the mode control unit 100 may receive the PWM signal from the outside to thereby calculate the pulse frequency and confirm whether the calculated pulse frequency of the PWM signal exceeds the preset frequency.

Next, when the calculated pulse frequency of the PWM signal exceeds the preset frequency, the mode control unit 100 may generate an operating signal and provide the operating signal to the regulator 200.

Meanwhile, even in the case in which the PWM signal is a high-level signal, the mode control unit 100 may generate the operating signal. That is, since only the pulse is not present in the PWM signal and 100% of the PWM signal is in the high-level state, such as a direct current (DC), it may be determined that the PWM high-level signal may also actually drive the motor. Therefore, even in the case in which the PWM signal is a high-level signal, the mode control unit 100 may generate the operating signal and provide the operating signal to the regulator 200.

That is, the mode control unit 100 may monitor a duty of the PWM signal and count a case in which a duty ratio exceeds 0% to thereby determine whether to exceed a preset value. Meanwhile, even in the case in which a wake-up signal is received from the outside, the mode control unit 100 may generate the operating signal and make a transition to an enable state of the regulator 200, and in the case in which the motor control module 300 receives a sleep signal from the outside in a normal mode, the mode control unit 100 may disable the regulator 200.

The regulator 200 may receive the operating signal from the mode control unit 100 to be transitioned to the enable state. That is, as a result of monitoring the PWM signal by the mode control unit 100, when the PWM signal satisfies a preset condition, in order to wake-up the motor control module 300, the regulator 200 may receive the operating signal and may be transitioned to the enable state. Next, the regulator 200 may generate an operating voltage and provide the operating voltage to the motor control module 300.

In addition, when the regulator 200 generates the operating voltage and then reaches a normal state by increasing the operating voltage, the regulator 200 may reset a mode of the motor control module 300 and the motor control module 300 may then be in a normal mode.

The motor control module 300 may receive the operating voltage from the regulator 200 and control the operation of the motor.

Meanwhile, the mode control unit 100 may control the regulator 200 to maintain the enable state during a time (hereinafter, a sleep mask time), set using a clock signal received from the outside.

Here, the sleep mask time refers to a time set by the mode control unit 100 using the clock signal received from the outside. That is, the mode control unit 100 may generate the operating signal and enable the regulator 200. In this case, the regulator 200 may generate the operating voltage and increase the generated operating voltage.

However, in this process, the sleep signal is provided from the outside, such that the regulator 200 may be re-transitioned to the sleep mode. In the case in which the regulator 200 is re-transitioned to the sleep mode, the regulator 200 may be transitioned to a disabled state and the driving voltage may be provided to a ground gnd. As a result, the motor may be damaged or may malfunction.

Therefore, the regulator 200 is maintained in the enable state by blocking the sleep signal provided from the outside during the time, set using the clock signal provided from the outside, that is, the sleep mask time, such that the re-transition of the regulator 200 to the sleep mode may be prevented.

A detailed description thereof will be provided below with reference to FIGS. 2 through 4.

FIG. 2 is a block diagram illustrating details of the mode control unit 100 in the motor drive controller of FIG. 1.

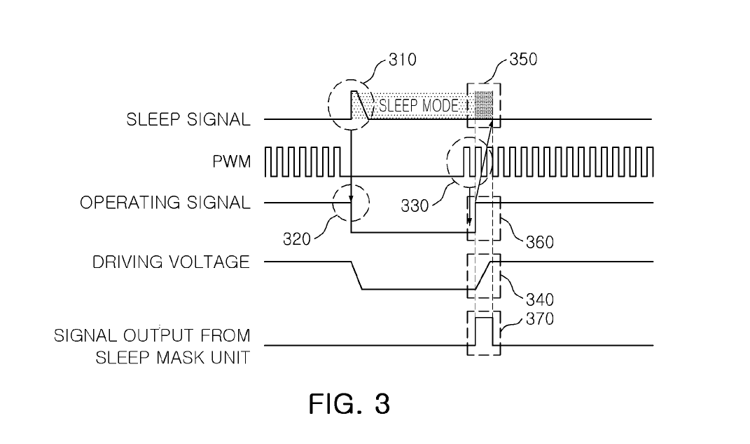

FIG. 3 is a diagram illustrating characteristics of signals associated with the motor drive controller of FIG. 1.

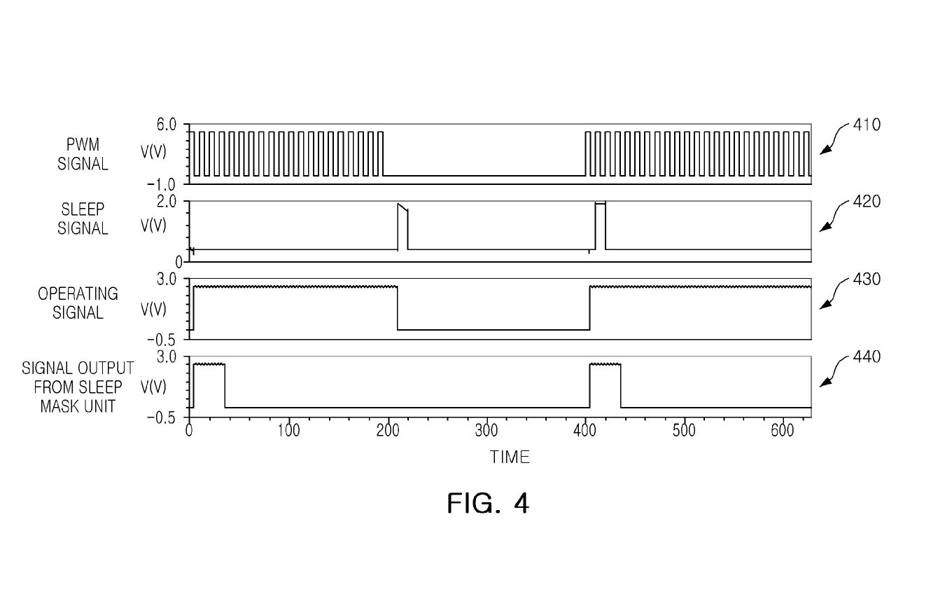

FIG. 4 is a diagram illustrating simulation results of the signals of FIG. 3.

Referring to FIG. 2, the mode control unit 100 may include a glitch remover 110, a counter 120, a sleep mask unit 130, and a latch circuit unit 140.

The glitch remover 110 may remove glitches from a PWM signal provided from the outside and provide the PWM signal from which the glitches have been removed to the latch circuit unit 140. More specifically, a peak within 1 μs of the PWM signal may be removed. The reason is that the PWM signal is provided from the outside as described above and a plurality of noise components are present in the PWM signal.

That is, the glitch remover 110 may remove glitches from the PWM signal provided from the outside to prevent malfunction caused by the noise components.

The latch circuit unit 140 may receive the PWM signal provided from the glitch remover 110 and a signal output from the sleep mask unit 130, respectively, and may generate an operating signal to be provided to the regulator 200.

The counter 120 may count a pulse frequency of the PWM signal and determine whether the pulse frequency of the PWM signal exceeds a preset frequency.

Meanwhile, the counter 120 may set a sleep mask time using a clock signal provided from the outside. The clock signal may be for example, a clock signal of a sleep oscillator, which is present outside the motor drive controller. Here, the sleep mask time may be a value obtained by calculating a period of a 64*14*clock signal by way of example.

The sleep mask unit 130 may block a sleep signal provided from the outside during the sleep mask time to thereby maintain the regulator 200 in an enable state, so that the regulator 200 is prevented from being re-transitioned to a sleep mode. A detailed description thereof will be provided below with reference to FIGS. 3 and 4.

Referring to FIGS. 3 and 4, when the motor is in an operating state and the motor control module 300 is in a normal mode, a sleep signal may be provided to the sleep mask unit 130 of the mode control unit 100 (310). Here, glitches are removed from the PWM signal provided from the outside by the glitch remover 110 and the PWM signal from which the glitches have been removed is input to the latch circuit unit 140.

That is, the output signal (low signal) from the sleep mask unit 130 and the PWM signal from which glitches have been removed are input to the latch circuit unit 140, such that the latch circuit unit 140 may generate and provide an operating signal 320 for transitioning the regulator 200 to the sleep mode. In this case, the regulator 200 may be in a disabled state and driving voltage may be provided to the ground.

Next, the glitch remover 110 of the mode control unit 100 may remove the glitches from the PWM signal provided from the outside and provide the PWM signal from which the glitches have been removed to the latch circuit unit 140. Meanwhile, the counter 120 may determine the pulse frequency of the PWM signal (determine whether the pulse frequency of the PWM signal exceeds a preset condition, for example, four times) and provide it to the sleep mask unit 130. In addition, the counter 120 may set a sleep mask time 350 using a clock signal provided from the outside.

In this case, the sleep mask unit 130 may block the sleep signal provided from the outside during the sleep mask time 350. That is, the sleep mask unit 130 may provide a high output signal 370 to the latch circuit unit 140 and the latch circuit unit 140 may generate and provide an operating signal 360 for operating the regulator 200 using the high output signal 370.

Next, the regulator 200 may receive the operating signal 360 to generate a driving voltage 340, and increase the generated driving voltage to allow the motor control module 300 to be operated in a normal mode.

That is, in order to prevent the regulator 200 from being in the disabled state due to the sleep signal during the sleep mask time, the sleep mask unit 130 may generate a high output signal and provide the output signal to the latch circuit unit 140, thereby preventing the motor control module 300 from being transitioned to the sleep mode.

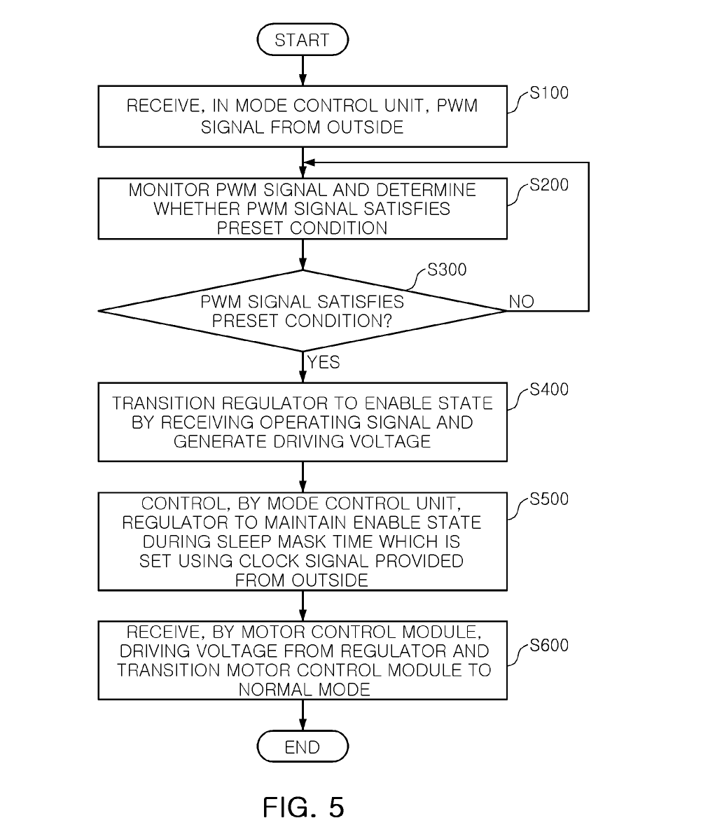

FIG. 5 is a flowchart illustrating a motor drive control method according to another exemplary embodiment of the present disclosure.

Referring to FIG. 5, a motor drive control method may include receiving, in the mode control unit 100, a PWM signal from the outside (S100); monitoring the PWM signal and determining whether the PWM signal satisfies a preset condition (S200); generating, by the mode control unit, an operating signal when the PWM signal satisfies the preset condition and providing the operating signal to the regulator 200 (S300); transitioning the regulator 200 to an enable state by receiving the operating signal and generating a driving voltage (S400); controlling, by the mode control unit 100, the regulator 200 to maintain the enable state during a sleep mask time set using a clock signal provided from the outside (S500); and receiving, in the motor control module 300, the driving voltage from the regulator 200 and transitioning the motor control module 300 to a normal mode (S600).

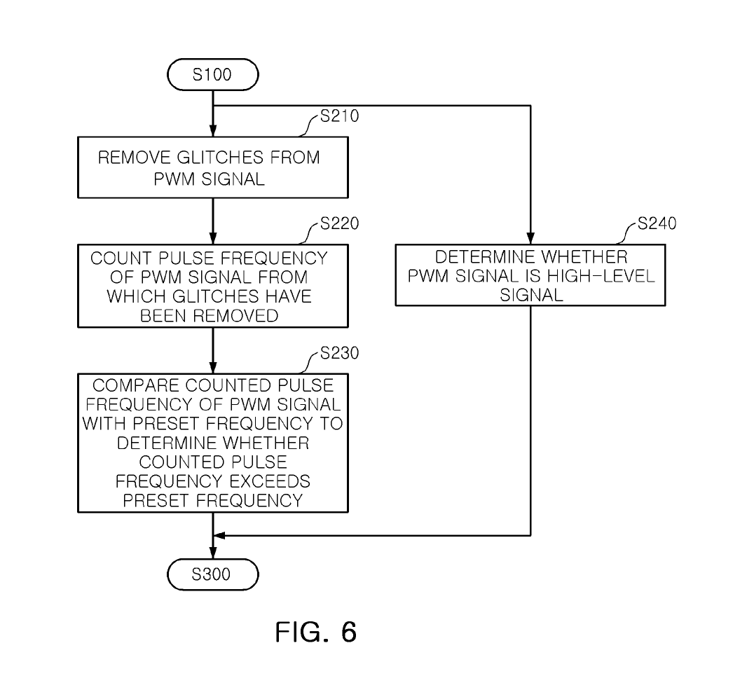

FIG. 6 is a flowchart showing a method of determining whether the PWM signal satisfies the preset condition in the motor drive control method illustrated in the flowchart of FIG. 5.

Referring to FIGS. 2, 5 and 6, the method of determining whether the PWM signal satisfies the preset condition may include removing, by the glitch remover 110, glitches from the PWM signal (S210); counting a pulse frequency of the PWM signal (S220); and comparing the counted pulse frequency of the PWM signal with a preset frequency to determine whether the counted pulse frequency of the PWM signal exceeds the preset frequency (S230). Meanwhile, the method of determining whether the PWM signal satisfies the preset condition may further include determining whether the PWM signal is a high-level signal (S240). Next, as a result of the comparing and determining operations, the mode control unit 100 may generate a driving signal and provide the driving signal to the regulator 200.

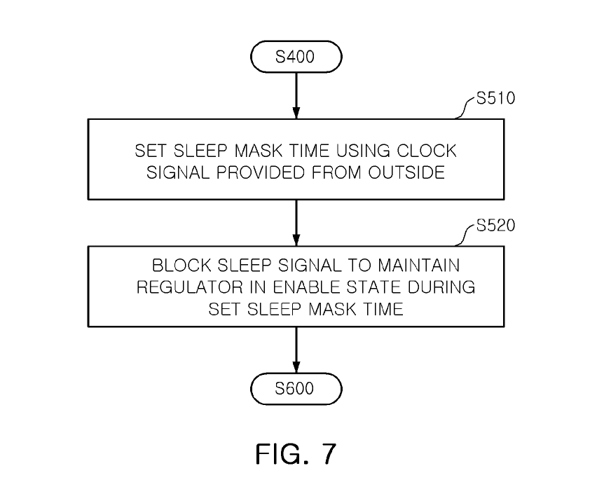

FIG. 7 is a flowchart illustrating a method of controlling the regulator to maintain an enable state during the sleep mask time in the motor drive control method illustrated in the flowchart of FIG. 5.

Referring to FIGS. 2, 5, and 7, the method of controlling the regulator 200 to maintain the enable state during the sleep mask time may include setting the sleep mask time using a clock signal from the outside (S510) and controlling the regulator 200 to maintain the enable state during the set sleep mask time (S520).

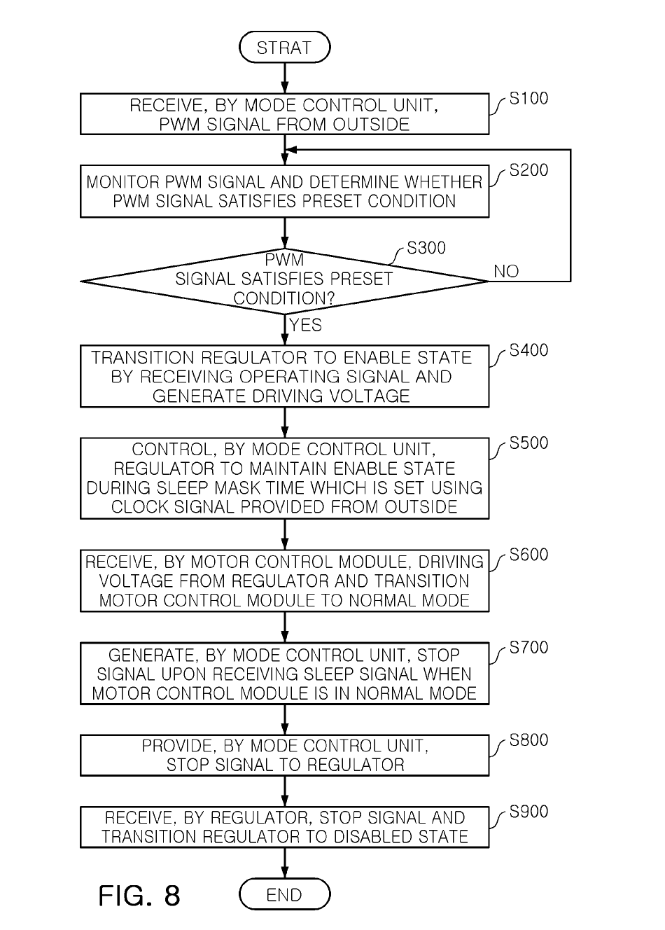

FIG. 8 is a flowchart illustrating details of the motor drive control method illustrated in the flowchart of FIG. 5.

Referring to FIGS. 2, 5, and 8, the motor drive control method may further include generating, by the mode control unit 100, a stop signal upon receiving the sleep signal when the motor control module 300 is in a normal mode (S700); providing, by the mode control unit 100, the stop signal to the regulator 200 (S800); and receiving, in the regulator 200, the stop signal and transitioning the regulator 200 to a disabled state (S900).

As set forth above, according to exemplary embodiments of the present disclosure, the motor drive controller and the motor drive control method may prevent the motor control module from being re-transitioned to a sleep mode by a sleep signal provided from the outside during a process (sleep mask time) in which the motor control module is woken-up, whereby damage to the motor and malfunctioning of the motor may be prevented and low power management of the motor control module may be realized.

While exemplary embodiments have been shown and described above, it will be apparent to those skilled in the art that modifications and variations could be made without departing from the spirit and scope of the present disclosure as defined by the appended claims.

What is claimed is:

1. A motor drive controller, comprising:
a mode control unit calculating a pulse frequency of a pulse width modulation (PWM) signal provided from an outside and generating an operating signal according to the calculated pulse frequency of the PWM signal;
a regulator receiving the operating signal, transitioning to an enable state based on the operating signal, and generating a driving voltage; and
a motor control module receiving the driving voltage from the regulator and controlling an operation of a motor,
wherein the mode control unit is configured to set up a sleep mask time using a clock signal provided from the outside and control the regulator to maintain the enable state during the sleep mask time.

2. The motor drive controller of claim 1, wherein the mode control unit generates the operating signal when the pulse frequency of the PWM signal exceeds a preset frequency.

3. The motor drive controller of claim 1, wherein the mode control unit generates the operating signal when the PWM signal is a high-level signal.

4. The motor drive controller of claim 1, wherein the mode control unit blocks a sleep signal provided from the outside during the sleep mask time and controls the regulator to maintain the enable state.

5. The motor drive controller of claim 1, wherein the mode control unit includes:
a glitch remover removing glitches from the PWM signal;
a counter counting the pulse frequency of the PWM signal;
a sleep mask unit receiving a sleep signal from the outside; and
a latch circuit unit receiving the PWM signal from the glitch remover and a signal output from the sleep mask unit and generating the operating signal.

6. The motor drive controller of claim 5, wherein the counter sets the sleep mask time using the clock signal.

7. The motor drive controller of claim 6, wherein the sleep mask unit provides a high output signal to the latch circuit unit during the sleep mask time so that the regulator is maintained in the enable state.

8. A motor drive controller, comprising:
a mode control unit generating an operating signal when a duty of a PWM signal provided from the outside satisfies a preset condition by monitoring the duty of the PWM signal or when a wake-up signal is received from the outside;
a regulator receiving the operating signal, transitioning to an enable state based on the operating signal, and generating a driving voltage; and
a motor control module receiving the driving voltage from the regulator to be transitioned to a normal mode,
wherein the mode control unit includes a sleep mask unit controlling the motor control module to maintain the normal mode for a preset time after the mode control unit generates the operating signal and provides the generated operating signal to the regulator.

9. The motor drive controller of claim 8, wherein the mode control unit includes:
a glitch remover removing glitches from the PWM signal;
a counter receiving a clock signal provided from the outside and counting a sleep mask time; and
a latch circuit unit receiving the PWM signal from the glitch remover and a signal output from the sleep mask unit and generating the operating signal,
wherein the signal output from the sleep mask unit has a high level during the preset time.

10. The motor drive controller of claim 8, wherein the mode control unit counts a case in which a duty ratio of the PWM signal exceeds 0% and generates the operating signal when the counted case exceeds a preset value.

11. The motor drive controller of claim 8, wherein the mode control unit generates a signal transitioning the regulator to an enable state upon receiving a sleep signal when the motor control module is in a normal mode and provides the generated signal to the regulator.

12. A motor drive control method, comprising:
receiving, in a mode control unit, a PWM signal from the outside;
monitoring the PWM signal and determining whether the PWM signal satisfies a preset condition;
generating, by the mode control unit, an operating signal when the PWM signal satisfies the preset condition and providing the operating signal to a regulator;
transitioning the regulator to an enable state by receiving the operating signal and generating a driving voltage;
controlling, by the mode control unit, the regulator to maintain the enable state during a sleep mask time which is set using a clock signal provided from the outside; and
receiving, in the motor control module, the driving voltage from the regulator and transitioning the motor control module to a normal mode.

13. The motor drive control method of claim 12, wherein the determining whether the PWM signal satisfies the preset condition includes:
removing, by a glitch remover, glitches from the PWM signal provided from the outside;
counting a pulse frequency of the PWM signal provided from the outside; and
comparing the counted pulse frequency of the PWM signal with a preset frequency to determine whether the counted pulse frequency of the PWM signal exceeds the preset frequency.

14. The motor drive control method of claim 12, wherein the determining whether the PWM signal satisfies the preset condition includes determining whether the PWM signal is a high-level signal.

15. The motor drive control method of claim 12, wherein the controlling of the regulator to maintain the enable state includes:
setting the sleep mask time using the clock signal from the outside; and
controlling the regulator to maintain the enable state during the set sleep mask time.

16. The motor drive control method of claim 12, further comprising:
generating, by the mode control unit, a stop signal upon receiving a sleep signal when the motor control module is in a normal mode;
providing, by the mode control unit, the stop signal to the regulator; and
receiving, in the regulator, the stop signal and transitioning the regulator to a disabled state.
